(19) United States
(12) Patent Application Publication
(10) Pub. No.: US 2016/0028905 A1
(43) Pub. Date: Jan. 28, 2016

(54) IMAGE PROCESSING APPARATUS, METHOD FOR CONTROLLING THE SAME, AND STORAGE MEDIUM

(71) Applicant: Yohei Shogaki, Kawasaki-shi (JP)

(72) Inventor: Yohei Shogaki, Kawasaki-shi (JP)

(21) Appl. No.: 14/378,703

(22) PCT Filed: Feb. 12, 2013
(86) PCT No.: PCT/JP2013/000739

§ 371 Date: Aug. 14, 2014

(30) Foreign Application Priority Data
Feb. 15, 2012 (JP) 2012-030817

(51) Int. Cl. H04N 1/00; G06F 3/0488; G06F 3/0485; G06F 3/041; G06F 3/048

(52) U.S. Cl. CPC H04N 1/00456; G06F 3/041; G06F 3/048; H04N 1/00411; G06F 3/0485; G06F 3/04883; G06F 2203/04803; H04N 2201/0094

(57) ABSTRACT

An image processing apparatus displays, in a display unit including a touch panel, image data for one page including a plurality of document images which are arranged. When a user performs a flicking operation on the touch panel, the image processing apparatus shifts a display region displayed in the display unit from a first region to a second region of the image data in accordance with a direction of the flicking operation. When one of the arranged document images corresponding to the image data is included in the second region, the image processing apparatus performs shift after changing a shift destination so that the document image is displayed in a predetermined position of the display region.

### TECHNICAL FIELD

The present invention relates to an image processing apparatus, a method for controlling the image processing apparatus, and a storage medium.

### BACKGROUND ART

In recent years, information processing apparatuses including a touch panel have been widely used. In such an information processing apparatus, an arbitrary image displayed in a screen is scrolled by performing a flicking operation on the screen.

PTL 1 discloses a technique of displaying previews of images obtained by scanning in a touch panel disposed in a display unit included in a photocopier before printing so that a user may check pages by performing flicking operations.

### CITATION LIST

### Patent Literature

PTL 1: Japanese Patent Laid-Open No. 2011-237636

### SUMMARY OF INVENTION

In the foregoing general technique, images corresponding to pages are displayed in an aligned manner and the pages are scrolled by the flicking operations. In this technique, scrolling display performed in accordance with flicking operations in a case where a single page is displayed in an enlarged manner and only a portion of the page is displayed is not taken into consideration.

The present invention provides a method for displaying an image in accordance with a user's operation such as a flicking operation in a case where only a portion of the image is displayed, and provides improved usability.

The present invention provides an image processing apparatus including a display controller adapted to display, in a display unit including a touch panel, image data for one page including a plurality of document images which are arranged, and a shift unit adapted to shift, when a user performs a flicking operation on the touch panel, a display region displayed in the display unit from a first region to a second region of the image data in accordance with a direction of the flicking operation. When one of the arranged document images corresponding to the image data is included in the second region, the shift unit performs shift after changing a shift destination so that the document image is displayed in a predetermined position of the display region.

According to the present invention, when only a portion of an image is displayed and a user's operation such as a flicking operation is performed, shifting is performed so that a specific region of the image is displayed in a display region, and accordingly, improved usability is attained.

Further features of the present invention will become apparent from the following description of exemplary embodiments with reference to the attached drawings.

### BRIEF DESCRIPTION OF DRAWINGS

FIG. 1 is a block diagram illustrating hardware of an MFP according to an embodiment.

FIG. 2A is a diagram illustrating a screen displayed in a display of the MFP according to the embodiment.

FIG. 2B is a diagram illustrating a screen displayed in the display of the MFP according to the embodiment.

FIG. 3A is a diagram illustrating image data including specific regions according to the embodiment.

FIG. 3B is a diagram illustrating image data including specific regions according to the embodiment.

FIG. 4 is a flowchart illustrating a process performed by the MFP according to the embodiment.

FIG. 5A is a diagram illustrating display of previews according to the embodiment.

FIG. 5B is a diagram illustrating display of previews according to the embodiment.

FIG. 6 is a flowchart illustrating another process performed by the MFP according to the embodiment.

FIG. 7A is a diagram illustrating display of previews according to the embodiment.

FIG. 7B is a diagram illustrating display of previews according to the embodiment.

FIG. 8 is a flowchart illustrating a further process performed by the MFP according to the embodiment.

FIG. 9 is a diagram illustrating display of previews according to the embodiment.

### DESCRIPTION OF EMBODIMENTS

Hereinafter, preferred embodiments of the present invention will be described with reference to the accompanying drawings. Note that the present invention according to claims is not limited to the embodiments described herein and it is not necessarily the case that all combinations of features described in the embodiments are essential to solve the problems of the present invention.

### First Embodiment

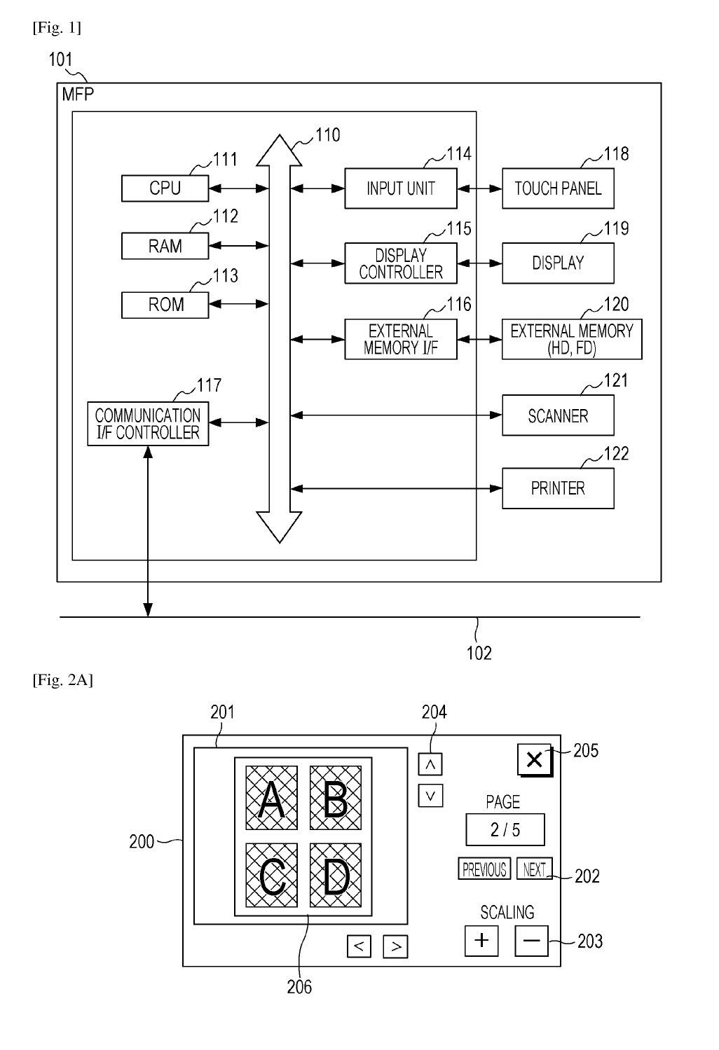

FIG. 1 is a diagram illustrating a hardware configuration of an MFP (Multi Function Peripheral) serving as an example of an apparatus embodying the present invention.

In FIG. 1, a CPU 111, a RAM 112, a ROM 113, an input unit 114, a display controller 115, an external memory I/F 116, and a communication I/F controller 117 are connected to a system bus 110. Furthermore, a touch panel 118, a display 119, and an external memory 120 are connected to the system bus 110 through the input unit 114, the display controller 115, and the external memory I/F 116, respectively. The units connected to the system bus 110 may transmit data to and receive data from one another through the system bus 110.

The ROM 113 is a nonvolatile memory which stores image data, other data, and various programs used to operate the CPU 111 in respective predetermined regions. The RAM 112 is a volatile memory and used as a main memory of the CPU 111 and a temporal storage region such as a work area. The CPU 111 controls the units included in the MFP 101 in accordance with the programs stored in the ROM 113, for example, using the RAM 112 as a work memory. Note that programs used to operate the MFP 101 are not limited to those stored in the ROM 113 but may be stored in the external memory 120 (such as a hard disk) in advance.

The input unit 114 accepts a user's operation, generates a control signal in accordance with the operation, and supplies the control signal to the CPU 111. For example, the input unit 114 includes, as input devices which accept user's operations, text information input devices (not shown) such as a keyboard, and pointing devices such as a mouse (not shown) and the touch panel 118. Note that the touch panel 118 is an input device which outputs coordinate information corresponding to a touched portion in the input unit 114 configured as a plane, for example. The CPU 111 controls the units of the MFP 101 in accordance with the programs operated in accordance with control signals generated and supplied by the input unit 114 in accordance with user's operations performed on the input device. By this, the CPU 111 may cause the MFP 101 to perform operations in accordance with user's operations.

The display controller 115 outputs a display signal used to display an image to the display 119. For example, a display control signal generated by the CPU 111 in accordance with a program is supplied to the display controller 115. The display controller 115 generates a display signal in accordance with the display control signal and outputs the display signal to the display 119. For example, the display controller 115 causes the display 119 to display a GUI screen including GUIs (Graphical User Interfaces) in accordance with the display control signal generated by the CPU 111.

The touch panel 118 is integrally configured with the display 119. For example, the touch panel 118 is configured such that light transmittance does not disturb a display operation performed by the display 119, and is disposed in an upper layer of a display plane of the display 119. Input coordinates of the touch panel 118 are associated with display coordinates of the display 119. By this, GUIs are configured as if the user may directly operate the screen displayed in the display 119.

To the external memory I/F 116, the external memory 120 such as a hard disk, a floppy disk (registered trademark), a CD (Compact Disc), a DVD (Digital Versatile Disc), or a memory card is attachable. Under control of the CPU 111, the external memory I/F 116 reads data from the attached external memory 120 and writes data to the attached external memory 120. The communication I/F controller 117 performs communication with a network 102 such as a LAN (Local Area Network), the Internet, a wired network, or a wireless network under control of the CPU 111. Various apparatuses such as PCs, other MFPs, printers, and servers are connected to the network 102 so as to communicate with the MFP 101.

A scanner 121 reads documents and generates image data. A printer 122 executes a printing process in accordance with a user's instruction input through the input unit 114 or a command input by an external apparatus through the communication I/F controller 117.

Note that the CPU 111 may detect the following operations performed on the touch panel 118 and the following states, for example: touch on the touch panel by a finger or a pen (hereinafter referred to as “touch down”); a state in which the touch panel is touched by a finger or a pen (hereinafter referred to as “touch on”); a movement of a finger or a pen while the finger or the pen touches the touch panel (hereinafter referred to as “movement”); release of a finger or a pen from the touch panel (hereinafter referred to as “touch up”); a state in which the touch panel is not touched by any object (hereinafter referred to as “touch off”); and the like. These operations and coordinates of positions of portions touched by a finger or a pen on the touch panel are transmitted to the CPU 111 through the system bus 110. The CPU 111 determines an operation performed on the touch panel in accordance with the supplied information. As for “movement”, a direction of a movement of a finger or a pen which moves on the touch panel may be determined in accordance with shift of a position coordinate on the basis of a vertical component and a horizontal coordinate on the touch panel. Furthermore, it is determined that a series of operations from “touch down” on the touch panel through certain “movement” to “touch up” corresponds to a stroke. A quick stroke is referred to as “flicking”. The flicking is an operation of quickly moving a finger touching the touch panel by a certain distance and releasing the finger from the touch panel. That is, the flicking is an operation of quickly tracing a line on the touch panel such that the touch panel is flicked by the finger. The CPU 111 may determine that the flicking is performed when “movement” performed at a predetermined speed or more by a predetermined distance or more is detected and thereafter “touch up” is detected. When “movement” by a predetermined distance or more is detected and thereafter “touch on” is detected, it is determined that dragging is performed. As the touch panel 118, a touch panel employing any method may be used such as a resistance film method, an electrostatic capacitance method, a surface acoustic wave method, an infrared method, an electromagnetic induction method, an image recognition method, an optical sensor method, or the like.

Next, a preview function included in the MFP 101 will be described. In this embodiment, the preview function enables display of image data stored in the RAM 112 or the external memory 120 in the display 119. The CPU 111 generates image data of a format suitable for display in the display 119 from the image data. Hereinafter, the image data of the format suitable for display in the display 119 is referred to as a “preview image”. Note that the image data stored in the external memory 120 may include a plurality of pages, and in this case, preview images corresponding to the pages are generated. The preview function is applicable to not only previews before printing performed by the printer 122 but also checking of content of image data and the like.

The MFP 101 may store image data in the RAM 112 or the external memory 120 by one or more methods. Examples of the methods include a method for storing image data generated from a document read by the scanner 121. Furthermore, the examples of the methods include a method for storing image data received from an external apparatus such as a PC connected to the network 102 through the communication I/F controller 117. Moreover, the examples of the methods include a method for storing image data received from a portable storage medium (such as a USB memory or a memory card) installed in the external memory I/F 116. Alternatively, image data may be stored in the external memory 120 by another method. Note that displayed image data may include text information, image information such as a photograph or a graphic image, both of the text information and the image information, or other information.

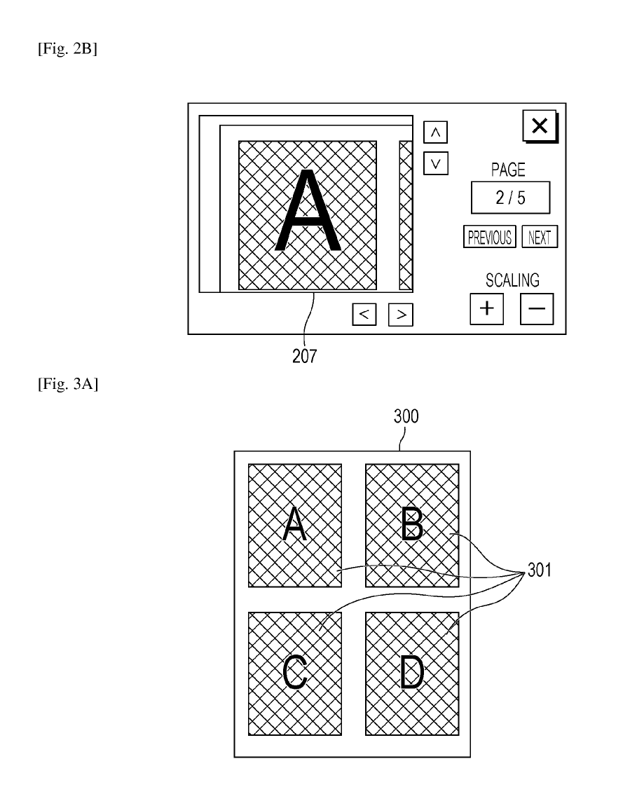

FIGS. 2A and 2B are diagrams illustrating screens in states in which preview images are displayed in the display 119 of the MFP 101. A preview screen 200 illustrated in FIG. 2A displays a preview image and includes a preview display region 201, a page scrolling button 202, a scaling button 203, a display region shifting button 204, and a close button 205. The preview display region 201 is used to display a preview image 206. In FIG. 2, a certain preview image (one page) is displayed in the preview display region 201 as an example. However, a portion of a preview image of a preceding page and a portion of a preview image of a succeeding page may be displayed on opposite sides in the preview display region 201 so that the preceding and succeeding pages of the certain page are recognized. Alternatively, a plurality of pages may be displayed in the preview display region 201. The page scrolling button 202 may be pressed when a preceding page or a succeeding page of the certain page exists. When the page scrolling button 202 is pressed, a page of the preview image 206 displayed in the preview display region 201 may be changed to another page in a direction represented by the button pressed by the user. The scaling button 203 is used to change a display magnification of the preview image 206 displayed in the preview display region 201. The user may change the display magnification by selecting arbitrary one of a plurality of levels of the display magnification. The display region shifting button 204 is used to change a display position of the preview image 206 displayed in the preview display region 201. When the display magnification becomes high by operating the scaling button 203, only a portion of the preview image 206 may be displayed in the preview display region 201. In this case, an arbitrary portion of the preview image 206 may be displayed using the display region shifting button 204. The close button 205 is used to close the preview screen 200 so as to display another screen and terminate the preview function.

The MFP 101 may operate display of the preview image 206 by a predetermined gesture operation instead of operations of the page scrolling button 202, the scaling button 203, and the display region shifting button 204. The gesture operation include, in addition to the flicking and the dragging described above, a pinch-out operation which is an operation of touching two or more points of the touch panel (touch down) and stretching a distance between the points and a pinch-in operation which is an operation of shrinking the distance. Other operations may be employed as the gesture operation. Note that, as a setting for determining an apparatus operation of the MFP 101, a result of a determination as to whether the gesture operation is accepted may be changed. When the gesture operation is accepted as the setting, the page scrolling button 202, the scaling button 203, the display region shifting button 204, and the like may not be displayed.

In the example of FIGS. 2A and 2B, image data which has been subjected to a page aggregation setting is displayed as a preview. In the page aggregation setting, sizes of document images of a plurality of pages are reduced and size-reduced document images are arranged on a sheet. A case where document images of N pages are arranged on a sheet is referred to as “N-in-1 layout”. Specifically, a case where document images of two pages are arranged on a sheet is referred to as “2-in-1 layout” and a case where document images of four pages are arranged on a sheet is referred to as “4-in-1 layout”. The MFP 101 of this embodiment accepts settings of 2-in-1 layout, 4-in-1 layout, 6-in-1 layout, 8-in-1 layout, and the like as the page aggregation setting. The preview image 206 illustrated in FIG. 2A corresponds to a case of the page aggregation setting of 4-in-1 layout of four document images, that is, document images A to D.

FIG. 2B is a diagram illustrating display of the preview image 206 which is enlarged by the user by pressing the scaling button 203 from the preview display state illustrated in FIG. 2A. An enlarged preview image 207 illustrated in FIG. 2B corresponds to a portion (upper left portion in this case) of the original preview image 206. Note that scaling of the preview image may be performed by the pinch-in operation or the pinch-out operation instead of the scaling button 203. Specifically, when the pinch-out operation is performed, high display magnification is obtained and the preview image 206 is displayed in an enlarged manner. On the other hand, when the pinch-in operation is performed, low display magnification is obtained and the preview image 206 is displayed in a size-reduced manner.

Here, a control operation of shifting a display region of a preview image by a flicking operation performed by the user will be described. In this embodiment, when the user performs a flicking operation by touching a preview image using a finger or a pen instead of pressing of the display region shifting button 204, the preview image is displayed in a scrolling manner so that a display region is shifted.

When detecting a flicking operation, the CPU 111 of the MFP 101 changes display content of the preview display region 201. The change of the display content means display of a second region shifted from a first region which is currently displayed. Here, the term “region” represents a portion of a preview image. A position of the second region is determined in accordance with a direction and strength of the flicking operation. The strength of the flicking operation is determined in accordance with a distance and a speed of “movement” of the flicking operation. In general, the larger the strength of the flicking operation is, the larger the distance between the first and second regions is. Furthermore, in a period of time from when the first region is displayed to when the second region is displayed, an image on a straight line between the first and second regions is displayed in a scrolling manner.

Next, a method for setting a specific region included in image data will be described. A specific region is included in image data and specified in accordance with a certain condition. Hereinafter, a concrete example of a specific region and a condition for determining the specific region will be described.

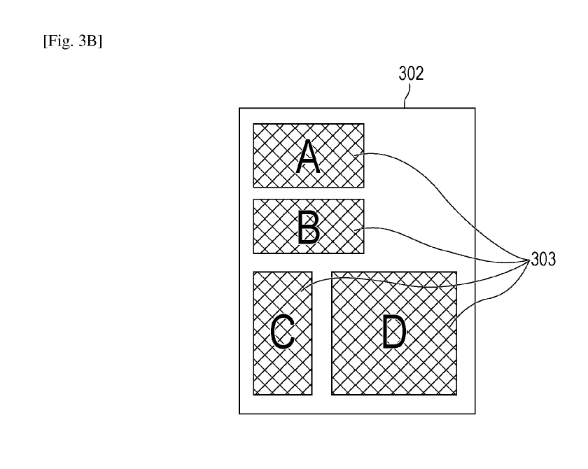

FIG. 3A is a diagram illustrating image data for one page which has been subjected to the page aggregation setting of the 4-in-1 layout. In this embodiment, a unit of page actually printed on a print sheet is referred to as a “physical page”. A reference numeral 300 of FIG. 3A denotes a physical page. Meanwhile, document images included in a physical page after the page aggregation setting is performed is referred to as “logical pages”. A reference numeral 301 of FIG. 3A denotes logical pages. For example, a condition “to be a logical page” may be used to determine a specific region included in image data. In this case, when the image data which has been subjected to the page aggregation setting is generated, the CPU 111 determines coordinates for arrangement of logical pages in accordance with the page aggregation setting (information such as 2-in-1 or 4-in-1). Thereafter, starting points and ending points in horizontal and vertical directions for layout of the logical pages may be recorded on the basis of the physical page and regions surrounded by coordinates of the starting points and the ending points may be determined as the specific regions 301.

Note that the specific regions may be determined by methods other than the method for setting the specific regions when the image process is performed by the CPU 111 as described above. For example, a region which has an attribute value representing a logical page may be stored in image data in advance and the CPU 111 may set a specific region by obtaining the value.

Furthermore, a condition for determining a specific region is not limited to the condition “to be a logical page” described above. For example, the CPU 111 of the MFP 101 may set a specific region in accordance with a result of an image region separation process performed when a document is read by the scanner 121. The image region separation process is a function of determining a text region, a photographic region, and a graphic region in a page by analyzing content of a read document image. Other types of region may be determined. One or more regions are set as specific regions using a result of the determination.

Furthermore, the process of shifting a display region by performing a flicking operation which is described in this embodiment is applicable to web pages, for example. In a web page, elements included in the page may be grouped so that certain groups such as a text group and an image group are obtained. Tags of a markup language (such as an HTML) which describe the web page are used for the grouping. In this case, coordinates in layout of images, sentences for one paragraph in text, and the like may be set as specific regions.

As described above, according to this embodiment, information obtained from displayed image data may be used as information used to determine specific regions, and types of the information, a determination condition, and a determination method are not particularly limited.

Accordingly, this embodiment is applicable to not only a case where the specific regions having a fixed size are defined in one page such as the case of the 4-in-1 layout illustrated in FIG. 3A but also a case of image data 302 of layout illustrated in FIG. 3B. In FIG. 3B, a reference numeral 303 denotes specific regions.

Note that a specific region may be determined in accordance with two or more coordinates or may be simply determined in accordance with a single coordinate. For example, regions obtained when image data for one page is equally divided into two or more regions may be set as specific regions. Specifically, when a length in a horizontal direction of the image data for one page is 300 pixels, division points for equally dividing the length into three regions have coordinate values of 100 and 200. The coordinate values may be used as references for determining the specific regions.

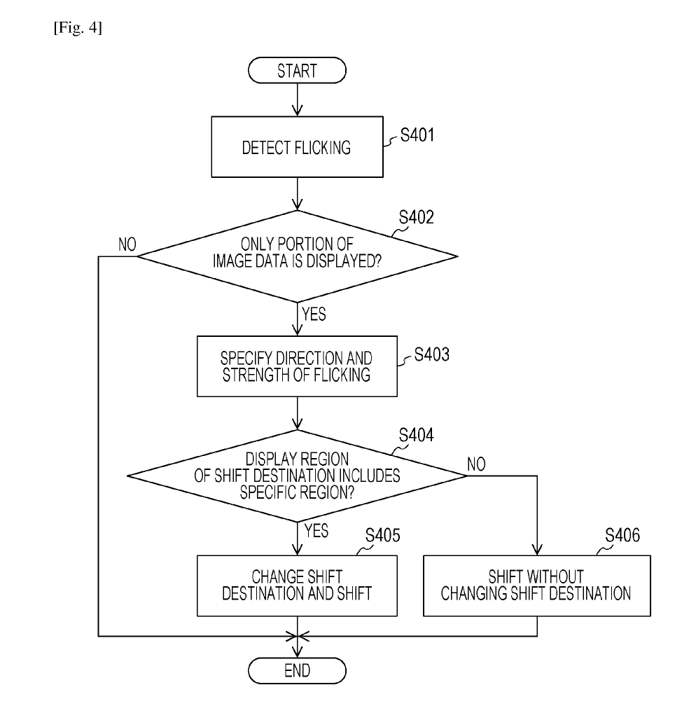

Next, a series of processes for changing display content of a preview image displayed in the display 119 will be described in detail with reference to a flowchart illustrated in FIG. 4. When the CPU 111 of the MFP 101 executes programs, processes in steps in FIG. 4 are performed. The programs are stored in a memory such as the ROM 113 or the external memory 120 and developed and executed in the RAM 112.

In step S401, the CPU 111 detects a flicking operation performed on a preview image displayed in the preview screen 200. Thereafter, in step S402, the CPU 111 determines whether the preview image currently displayed in the preview display region 201 corresponds to an entire page. Specifically, the CPU 111 determines whether only a portion of the preview image for one page is currently displayed in the preview display region 201. When it is determined that the preview image for one page protrudes from the preview display region 201 as illustrated in FIG. 2B, that is, only a portion of the preview image for one page is displayed, the process proceeds to step S403. On the other hand, when it is determined that the entire preview image for one page is accommodated in the preview display region 201 as illustrated in FIG. 2A, the display region is not shifted in the page. In this case, preview images of a plurality of pages are displayed in a scrolling manner so that a page corresponding to a preview image to be displayed is changed. However, this process is omitted in the flowchart of FIG. 4. Note that, when the pages are scrolled, a flicking operation which is effective as an operation of scrolling pages is performed only in the horizontal direction, and flicking operations in the vertical direction and a diagonal direction may be ignored.

In step S403, the CPU 111 detects a direction and strength of the flicking operation detected in step S401. As described above, the flicking direction may be detected in accordance with coordinates of “touch-down” and “touch-up”. The strength of the flicking operation may be determined in accordance with a distance and a speed of “movement”.

In step S404, the CPU 111 specifies a portion (coordinate) of a shift destination which is a display target of the preview display region 201 in accordance with the direction and the strength detected in step S403. Thereafter, the CPU 111 determines whether a specific region is included in a display region (or in the vicinity of the display region) of the specified shift destination.

When the determination is affirmative, the process proceeds to step S405 where the CPU 111 changes the portion of the shift destination so that the specific region becomes the portion of the shift destination. Then the CPU 111 causes the display 119 to display scrolling to the changed portion. Specifically, the display region is shifted without changing the magnification. Here, the change of the portion of the shift destination so that the specific region becomes the portion of the shift destination means that scrolling is performed to a portion so that the entire specific region is accommodated in the preview display region 201 when the preview display region 201 is capable of accommodating the entire specific region. On the other hand, the change of the portion of the shift destination so that the specific region becomes the portion of the shift destination means that scrolling is performed to a portion so that at least a specific portion (upper left portion, center portion, or upper right portion, for example) of the entire specific region is displayed in the preview display region 201 when the entire specific region is not accommodated in the preview display region 201. In this case, the specific portion is displayed in an upper left portion of the preview display region 201 when the specific portion corresponds to the upper left portion, the specific portion is displayed in a center portion of the preview display region 201 when the specific portion corresponds to the center portion, and the specific portion is displayed in an upper right portion of the preview display region 201 when the specific portion corresponds to the upper right portion.

When the determination is negative in step S404, the process proceeds to step S406. In step S406, the CPU 111 causes the display 119 to perform scrolling display to the portion (coordinate) of the shift destination specified in step S404.

Note that in the scrolling display performed in step S405, shift is performed to the specific region, and therefore, display may be performed until the scrolling is stopped in any of the following manners. First, shift is performed straightly to the specific region which is a final destination. In this case, a direction of the flicking operation performed by the user may be slightly different from an actual scrolling direction. Second, after shift is performed to the shift destination determined in accordance with the direction and the strength of the flicking operation, a direction of the shift is changed toward the specific region immediately before the shift is stopped at the shift destination. In this case, although the direction of the flicking operation performed by the user coincides with an actual scrolling direction, the direction of the scrolling is changed in a direction different from the flicking direction immediately before the scrolling display is stopped.

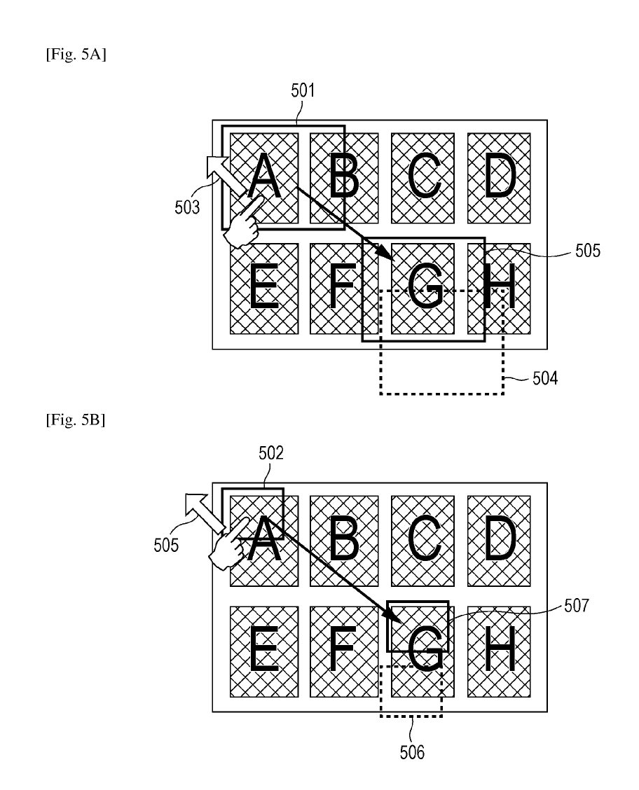

The process performed in accordance with the flowchart of FIG. 4 will be described in detail with reference to FIGS. 5A and 5B. FIGS. 5A and 5B are diagrams illustrating image data which has been subjected to the page aggregation setting of the 8-in-1 layout and which corresponds to a physical page including eight logical pages denoted by “A” to “H”. The physical page corresponds to a preview image to be displayed in a preview display region. Furthermore, in this example, the eight logical pages correspond to specific regions.

A portion represented by a reference numeral 501 of FIG. 5A corresponds to the preview display region 201 of the preview screen 200 and currently displays a portion of the preview image (the entire logical page A and a left half of the logical page B). Similarly, a portion represented by a reference numeral 502 of FIG. 5B corresponds to the preview display region 201 of the preview screen 200 and currently displays a portion of the preview image (an upper left portion of the logical page A). FIGS. 5A and 5B are different from each other in that whether the preview display region has a size which accommodates an entire logical page. Specifically, FIG. 5B is a diagram of a case where a portion of the preview image to be displayed is further enlarged from the state of FIG. 5A. In both of FIGS. 5A and 5B, a result of the determination made in step S402 is affirmative, and therefore, the process proceeds to step S403.

In the example of FIG. 5A, a case where a flicking operation is performed in a direction represented by a reference numeral 503 is taken as an example. It is assumed that, in step S404, as a result of specifying of a shift destination of a display target, a display region obtained after shift is represented by a reference numeral 504. Here, it is determined whether a specific region is included in (or in the vicinity of) the display region 504 obtained after the shift. In FIG. 5A, the logical pages G and H are included in the display region 504 obtained after the shift. As illustrated, when the plurality of specific regions are included in the display region 504, one of the specific regions having a larger area (range) in the display region 504 is determined as a specific region to be included in a display region of a shift destination after change of the shift destination. As a result, in the example of FIG. 5A, the shift destination is changed by the process performed in step S405 and a display region 505 is obtained after the change of the shift destination. In this case, display magnification of the display region 505 is the same as that of the display region 501. Accordingly, in the case where a display region has a size enough to display an entire specific region, when a portion of the specific region is not displayed in a shift destination determined by a flicking operation, the shift destination is corrected so that the entire specific region is displayed.

Similarly, in the example of FIG. 5B, a case where a flicking operation is performed in a direction represented by a reference numeral 505 is taken as an example. It is assumed that, in step S404, as a result of specifying of a shift destination of a display target, a display region obtained after shift is represented by a reference numeral 506. Here, it is determined whether a specific region is included in (or in the vicinity of) the display region 506 after the shift. In FIG. 5B, the logical page G is included in the display region 506 obtained after the shift. As a result, in the example of FIG. 5B, the shift destination is changed by the process performed in step S405 and a display region 507 is obtained after the change of the shift destination. In this case, display magnification of the display region 507 is the same as that of the display region 502. Accordingly, in the case where a display region is not large enough to display an entire specific region, a shift destination is corrected such that a specific portion (an upper left portion of the specific region in the example of FIG. 5B) included in the specific region is displayed in a certain position (an upper left portion in the example of FIG. 5B) of the display region, and scrolling display is performed.

Note that, in a case where the process is performed in accordance with the flowchart of FIG. 4, scrolling display may not be performed (display is not moved) even when a flicking operation is performed depending on a direction and strength of the flicking operation. For example, in the case of FIG. 5B, a flicking operation is performed upward in the state represented by the reference numeral 502 so that the display region is shifted downward, but a display region after the shift may be still in the logical page A. In this case, the display region is corrected so as to be located in the position represented by the reference numeral 502 by the process performed in step S405, and the scrolling display is not performed. The following control may be performed instead of such control. Specifically, the MFP 101 determines whether a specific region is currently displayed and stores the specific region when the determination is affirmative. When the specific region which is currently stored is included in a display region of a shift destination determined in accordance with a direction and strength of a flicking operation (or when the specific region has the largest area in the display region), the process in step S405 is disabled. Then a process in step S406 (a process of shifting the display region to the shift destination determined by the flicking operation) is performed instead.

By this, a state in which scrolling display is not performed although a flicking operation is performed may be avoided.

Although the determination as to whether a specific region is included in a display region of a shift destination determined in accordance with a direction and strength of a flicking operation is made in the example of FIG. 4, the determination may be made in accordance with only information on the direction. In this case, in step S404, a determination as to whether a specific region exists in a direction of scrolling display is made. When one or more specific regions are detected, one of the specific regions located on a near side (closest to a position of an intended display region) is determined as a shift destination.

Note that the direction determined by the flicking operation may be an arbitrary direction or may be corrected to a predetermined direction. For example, a vector is calculated and one of predetermined directions including a vertical direction, a horizontal direction, and a diagonal direction (four directions, eight directions, 16 directions, and the like) which is approximated to the calculated vector may be selected as a flicking direction.

As described above, according to this embodiment, in a case where, in a state in which only a portion of image data for one page is displayed, scrolling is performed so that another portion of the image data of the page is displayed, a specific region may be displayed instead of display of an intended shift destination. Alternatively, the scrolling may be stopped at a specific region.

By this, presence of a specific region included in image data for one page and content of the specific region may be efficiently displayed for the user and usability is further improved.

### Second Embodiment

In the first embodiment, the different control operations are performed depending on a result of the determination as to whether a specific region is included in a display region (or in the vicinity of the display region) of a shift destination. In a second embodiment, another different control operation is performed in accordance with another condition.

In this embodiment, configurations in FIGS. 1 to 3 are the same as those of the first embodiment, and therefore, descriptions thereof are omitted.

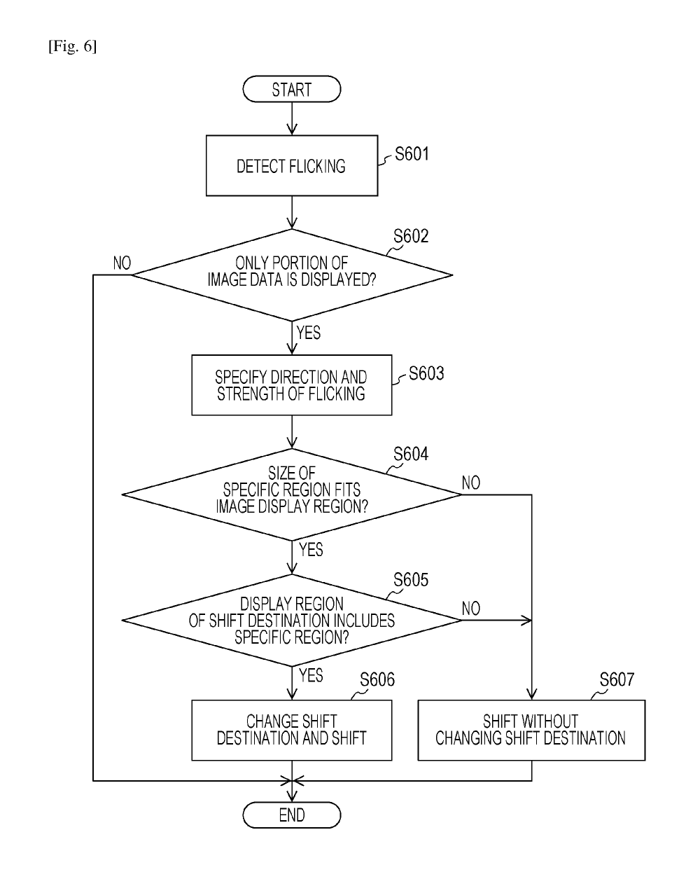

FIG. 6 is a flowchart illustrating a process of changing display content of a preview image displayed in a display 119 in response to a flicking operation performed by a user. When a CPU 111 of an MFP 101 executes programs, processes in steps in FIG. 6 are performed. The programs are stored in a memory such as a ROM 113 or an external memory 120 and developed and executed in a RAM 112.

Processes in step S601 to step S603 are the same as those in step S401 to step S403, and therefore, descriptions thereof are omitted.

In step S604, the CPU 111 determines whether a specific region included in a preview image fits a preview display region 201 in an appropriate size and in an appropriate position. When the determination is affirmative, the process proceeds to step S605. When the determination is negative, the process proceeds to step S607.

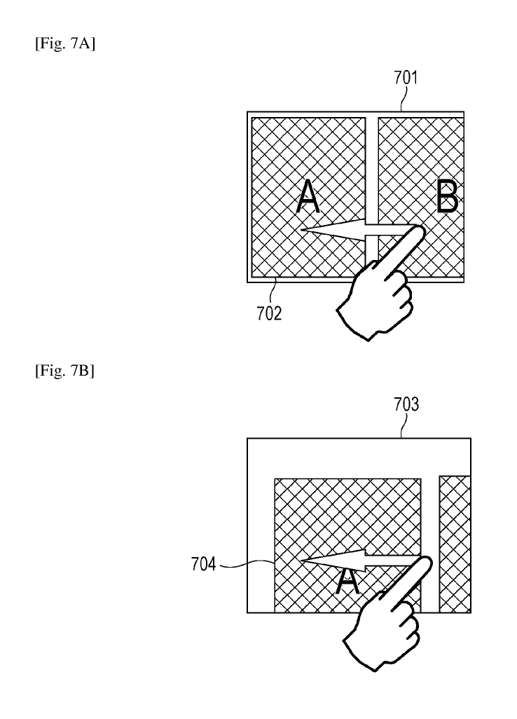

FIGS. 7A and 7B are diagrams illustrating display of the preview display region 201. A specific region 702 illustrated in FIG. 7A fits a preview display region 701. Specifically, in this fitting state (adapted state), an entire specific region is displayed without lack in vertical and horizontal directions and a vertical length or a horizontal length of the specific region (substantially) fits a vertical direction or a horizontal direction of the preview display region 701.

On the other hand, a specific region 704 illustrated in FIG. 7B does not fit a preview display region 703. Furthermore, a coordinate value of an upper left portion of the specific region 704 is considerably shifted from a coordinate value of an upper left portion of the preview display region 703.

A determination as to whether a specific region fits a preview display region in an appropriate size and in an appropriate position may be made in accordance with information representing whether a fitting mode is set. In the fitting mode, a display state as illustrated in FIG. 7A is obtained as preview display, and the preview image is arbitrarily changed in response to a user's operation performed on the MFP 101 or at a timing of updating a preview screen.

It is assumed that a specific region is included in a portion of a preview image displayed in a preview display region and the user performs a double tapping operation (quickly performs “touch-down” twice) on the specific region. In response to the double tapping operation, the CPU 111 performs control such that display of the specific region is changed so that the specific region fits the preview display region (the specific region is scaled) and a flag representing the fitting mode is set. Thereafter, when the specific region becomes out of the fitting state since the user performs an operation of changing magnification, an operation of shifting a display region, or the like in this state, a control operation of cancelling the set flag is performed. In this way, a determination as to whether the specific region fits the preview display region in an appropriate size and in an appropriate position may be made in accordance with a determination as to whether the flag representing the fitting mode is set. Alternatively, instead of the user's operation, the flag representing the fitting mode may be set when the preview screen is displayed first, and thereafter, when the specific region becomes out of the fitting state, the set flag may be cancelled.

In step S605, the CPU 111 determines whether a specific region is included in a display region (or in the vicinity of the display region) of a shift destination determined in accordance with a direction and strength of a flicking operation. When the determination is affirmative, the process proceeds to step S606. When the determination is negative, the process proceeds to step S607. The processes after the process of step S605 are the same as those after the process of step S405 illustrated in FIG. 4, and therefore, detailed descriptions thereof are omitted.

Note that, as with the first embodiment, the determination as to whether a specific region is included may be made in accordance with only information on the direction of the flicking operation in this embodiment. A process to be performed when a shift destination determined by a flicking operation is within a range of a specific region currently displayed may be performed similarly to the first embodiment.

Furthermore, in the flowchart illustrated in FIG. 6, a case where a plurality of logical pages included in a physical page have the same fixed size similarly to a case where a page aggregation setting of N-in-1 layout is performed is assumed. Specifically, a case where specific regions included in image data have the same fixed size is assumed. However, the process of the flowchart illustrated in FIG. 6 is applicable to a case where specific regions do not have fixed size but have different sizes and different shapes as illustrated in FIG. 3B. Accordingly, instead of the process in step S604, a determination as to whether a specific region included in (or in the vicinity of) a display region of a shift destination fits a preview display region may be made at a time when the shift destination is determined in accordance with a flicking operation.

As described above, according to this embodiment, when scrolling is performed to display another portion in a page by a flicking operation, instead of display of a shift destination intended by the scrolling, an image of a specific region having a size suitable for a display region may be displayed.

### Third Embodiment

According to the first and second embodiments, when display content is changed by a flicking operation, the determination as to whether a specific region exists or the determination as to whether a specific region fits an image display region is made. However, content of an image included in the specific region is not taken into consideration as a condition for the determinations. On the other hand, in a third embodiment, different control operations are further performed depending on content of an image included in a specific region.

For example, control is performed such that, when a set specific region does not include image data such as text and a photograph but is a blank region, the specific region (the blank specific region) is excepted from a candidate of a shift destination. Note that examples of the blank region include not only a region which is a completely blank state but also a region including an acnode or a certain image such as a noise image. Specifically, the blank region does not include meaningful information, that is, the blank region does not includes information such as text and an image and is not limited to a completely blank region.

As described in the first embodiment, a specific region is determined in accordance with certain conditions. In particular, in a case of image data which has been subjected to a page aggregation setting, a logical page is set as a specific region. When a document image corresponding to the logical page is blank, the specific region is excepted from a candidate of a shift destination.

Furthermore, the specific region which is excepted from a candidate of a shift destination is not limited to a blank region. The specific region which is excepted from a candidate of a shift destination may be determined in accordance with another condition. For example, when content of a specific region is text information, the specific region may be excepted from a candidate of a shift destination. This is convenient for a user who desires to preferentially display only photographs or graphic images. Accordingly, a condition of a specific region to be excepted from a candidate of a shift destination may be arbitrarily set by the user.

In this embodiment, configurations of FIGS. 1 to 3 are the same as those of the first embodiment, and therefore, descriptions thereof are omitted.

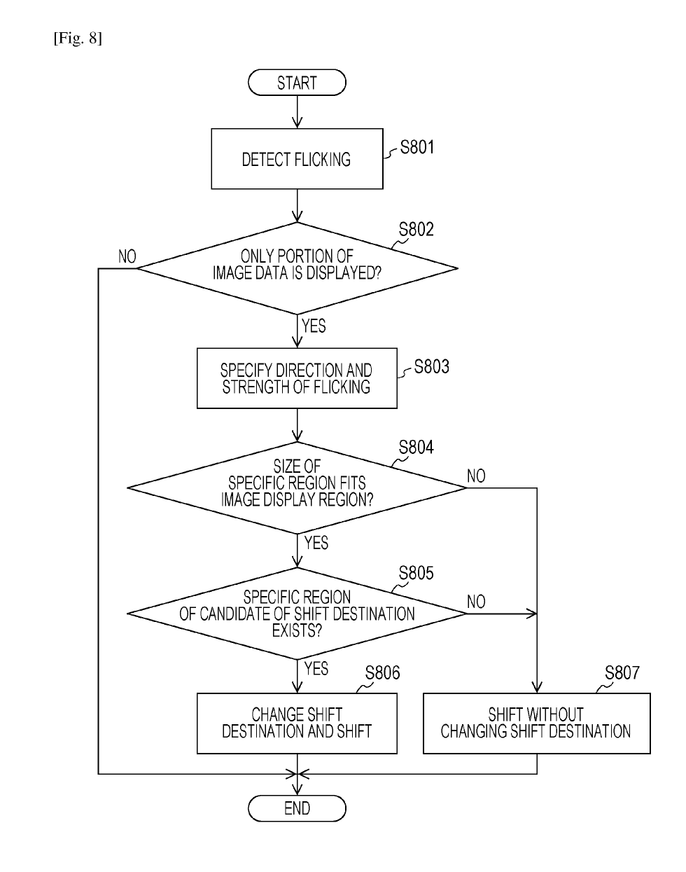

FIG. 8 is a flowchart illustrating a process of changing display content of a preview image displayed in a display 119 in response to a flicking operation performed by a user according to this embodiment. When a CPU 111 of an MFP 101 executes programs, processes in steps in FIG. 8 are performed. The programs are stored in a memory such as a ROM 113 or an external memory 120 and developed and executed in a RAM 112.

A process from step S801 to step S804 performed before a determination as to whether a specific region exists is made is the same as the process from step S401 to step S403 of the first embodiment and the process in step S604 of the second embodiment, and therefore, a description thereof is omitted.

In step S805, the CPU 111 determines whether a specific region serving as a candidate of a shift destination is included in a display region (or in the vicinity of the display region) of a shift destination determined in accordance with a direction and strength of a flicking operation. In accordance with the process described above, it is not determined that a specific region exists when a specific region to be excepted from a candidate of a shift destination is included in a display region (or in the vicinity of the display region) of the shift destination. When it is determined that a specific region serving as a candidate of a shift destination exists, the process proceeds to step S806. When the determination is negative, the process proceeds to step S807.

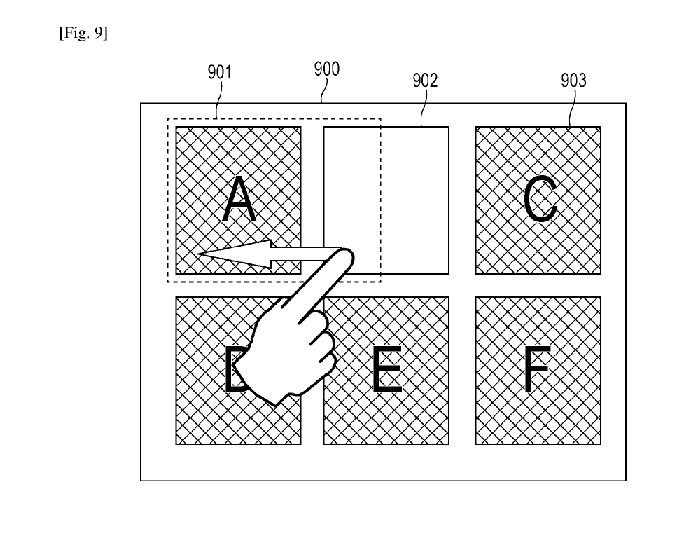

FIG. 9 is a diagram illustrating image data 900 which has been subjected to a page aggregation setting of 6-in-1 layout. A preview display region 901 corresponds to the image display region 201. In this state, when a flicking operation is performed in a direction represented by an arrow (left direction) in the drawing, the preview display region 901 is shifted rightward. In this case, although a specific region 902 exists in the shifting direction, since a blank logical page is set as a specific region to be excepted from a candidate of a shift destination, the specific region 902 is not determined as a specific region of a candidate of a shift destination. Furthermore, since a specific region 903 further exists in the shifting direction, the specific region 903 is determined as a specific region of a shift destination.

The processes after the process of step S806 are the same as those after the process of step S405 illustrated in FIG. 4, and therefore, detailed descriptions thereof are omitted.

Note that, as with the first and second embodiments, the determination as to whether a specific region is included may be made in accordance with only information on the direction of the flicking operation in this embodiment. A process to be performed when a shift destination determined by a flicking operation is within a range of a specific region currently displayed may be performed similarly to the first and second embodiments.

As described above, according to this embodiment, when scrolling is performed so that a certain portion in a page is to be displayed by a flicking operation, instead of display of a shift destination determined by the scrolling, an image of a specific region intended by a user may be displayed.

### Other Embodiments

A single apparatus may be configured by combining the first to third embodiments. In this case, the apparatus may include the operation described in the first embodiment, the operation described in the second embodiment, and the operation described in the third embodiment as individual operation modes, and the operation modes may be automatically switched from one to another in accordance with an arbitrary condition. Alternatively, the operation modes may be manually switched from one to another in accordance with a user's instruction.

Furthermore, according to the descriptions of the foregoing embodiments, although an image displayed in the display unit including the touch panel is a preview image, images to be subjected to the processes of the present invention are not limited to preview images. The present invention is applicable to not only display of preview images but also any display of image data including specific information.

Furthermore, according to the descriptions of the foregoing embodiments, although the MFP is taken as an example embodying the present invention, an apparatus embodying the present invention is not limited to the MFP. Specifically, in addition to the MFP, the present invention is applicable to image forming apparatuses such as a printing apparatus, a scanner, a FAX, and a digital still camera and image processing apparatuses capable of processing at least image data including information processing apparatuses such as a PC and a mobile information terminal.

Furthermore, according to the descriptions of the foregoing embodiments, the flicking operation is taken as an example of an operation performed by a user to perform scrolling display. However, the present invention may be realized by other user's operations for performing the scrolling display instead of the flicking operation. For example, in a case where the scrolling display is also realized by an operation other than the flicking operation performed on the touch panel, the present invention is applicable to this case. Specifically, in a case where scrolling display of a displayed image is realized by a predetermined user's operation, the present invention is applicable to this case. Examples of the predetermined operation include a gesture operation performed by touching the touch panel instead of the flicking operation performed on the touch panel and a gesture operation performed without touching the touch panel (so-called space gesture operation). Furthermore, display of an image to be scrolled is not limited to display in the display unit including the touch panel and the image may be projected to some kind of screen using an image projection apparatus such as a projector. The scrolling display may be realized by performing a predetermined gesture operation (such as a space gesture operation) on the projected image.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-030817, filed Feb. 15, 2012, which is hereby incorporated by reference herein in its entirety.

1. An image processing apparatus, comprising:
a display controller adapted to display, in a display unit including a touch panel, image data for one page including a plurality of document images which are arranged; and
a shift unit adapted to shift, when a user performs a flicking operation on the touch panel, a display region displayed in the display unit from a first region to a second region of the image data in accordance with a direction of the flicking operation,
wherein, when one of the arranged document images corresponding to the image data is included in the second region, the shift unit performs shift after changing a shift destination so that the document image is displayed in a predetermined position of the display region.

2. The image processing apparatus according to claim 1, wherein, when a number of the document images are included in the second region, the shift unit performs shift after changing a shift destination so that one of the document images included in the second region which has a larger area in the second region is displayed in a predetermined position of the display region.

3. The image processing apparatus according to claim 1, wherein, when one of the arranged document images corresponding to the image data is included in the second region and the included document image fits the display region, the shift unit performs shift after changing a shift destination so that the document image is displayed in a predetermined position of the display region, and when one of the arranged document images corresponding to the image data is included in the second region but the included document image does not fit the display region, the shift unit shifts the display region from the first region to the second region without changing the shift destination.

4. The image processing apparatus according to claim 3, wherein, when one of the arranged document images corresponding to the image data is included in the second region and the included document image fits the display region, the shift unit performs shift after changing the shift destination so that the document image is displayed in the center of the display region.

5. The image processing apparatus according to claim 1, wherein, when one of the arranged document images corresponding to the image data is included in the second region and the included document image satisfies a specific condition, the shift unit shifts the display region from the first region to the second region without changing the shift destination.

6. The image processing apparatus according to claim 5, wherein the specific condition is a condition in which the document image does not include an image.

7. The image processing apparatus according to claim 1, further comprising:
a printing unit adapted to perform printing in accordance with image data generated by a document image,
wherein the image data displayed by the display controller corresponds to a preview image before printing performed by the printing unit.

8. An image processing apparatus, comprising:
a display controller adapted to display, in a display unit including a touch panel, image data for one page including a plurality of document images which are arranged; and
a shift unit adapted to shift, when a user performs a flicking operation on the touch panel, a display region displayed in the display unit to a direction specified by the flicking operation,
wherein, when one of the arranged document images corresponding to the image data exists in the direction, the shift unit performs shift after changing a shift destination so that the document image is displayed in a predetermined position of the display region.

9. An image processing apparatus, comprising:
a display controller adapted to display image data including a specific region which satisfies a predetermined condition in a display unit; and
a shift unit adapted to shift a display region displayed in the display unit from a first region to a second region of the image data,
wherein, when the specific region included in the image data is included in the second region, the shift unit performs shifting so that the specific region is displayed in a predetermined position of the display region.

10. An image processing apparatus, comprising:
a display controller adapted to display image data including a specific region which satisfies a predetermined condition in a display unit; and
a shift unit adapted to shift a display region displayed in the display unit in a direction specified by a user's operation,
wherein, when the specific region included in the image data exists in the direction, the shift unit performs shifting so that the specific region is displayed in a predetermined position of the display region.

11. A method for controlling an image processing apparatus, comprising:
a display control step of displaying, in a display unit including a touch panel, image data for one page including a plurality of document images which are arranged; and
a shift step of shifting, when a user performs a flicking operation on the touch panel, a display region displayed in the display unit from a first region to a second region of the image data in accordance with a direction of the flicking operation,
wherein, when one of the arranged document images corresponding to the image data is included in the second region, shift is performed after changing a shift destination so that the document image is displayed in a predetermined position of the display region in the shift step.

12. A storage medium which stores programs that cause a computer to execute the steps of the control method set forth in claim 11.
